(19) United States
(12) Patent Application Publication
(10) Pub. No.: US 2007/0035127 A1
(43) Pub. Date: Feb. 15, 2007

(54) Protective sleeve for tubular connection

(76) Inventor: Scott A. Benzie, Houston, TX (US)

Correspondence Address: STREETS & STEELE, 13831 NORTHWEST FREEWAY, SUITE 355, HOUSTON, TX, 77040, US

(21) Appl. No.: 11/202,872

(22) Filed: Aug. 12, 2005

(51) Int. Cl. F16L 47/00

(52) U.S. Cl. 285/294.2

(57) ABSTRACT

The invention includes tubular connections that include a box member having an internal thread, an outer sleeve disposed about the box member and a bonding layer bonding the outer sleeve to the box member. This connection is particularly useful to radially-expandable tubular connections used in the oil and gas exploration industry and is useful for preventing a crack to propagate through the protective sleeve into the box member, especially when the tubular connection is undergoing radial expansion. The bonding material may include an adhesive, a retaining compound, an anaerobic cure adhesive, solder, brazing metal, weld material or combinations thereof. To provide a bonding layer that blunts or arrests crack propagation before a crack reaches the box member, the bonding layer has a bonding strength that is less than a threshold crack-propagating bonding strength, which is about one-fifth of the cohesive strength of the box member.

### BACKGROUND OF THE INVENTION

1. Field of the Invention

This invention relates to oil and gas exploration and more particularly, to joint connections for radially expandable tubular members used in the oil and gas industry.

2. Description of the Related Art

In the oil and natural gas well drilling industry, strings of tubulars of different diameters are typically placed in a wellbore for purposes that include, for example, stabilizing a formation or protecting a borehole against elevated wellbore pressures. One of the newest and most demanding technologies involving these strings of tubulars used in well drilling today is “expandable technology” (See, for example, SPE paper 56500, “Expandable Tubular Solutions,” by A. Filippov, at al., 1999) in which tubular member may be plastically radially expanded to diameters larger than the original diameters in the wellbore, thereby minimizing the reduction in internal diameter of the ordinary telescopic well design.

In a conventional operation utilizing expandable technology, single tubulars are coupled together by threaded connections in an end-to-end manner to form a tubular string. The tubular string is then deployed in the well to a desired depth and radially plastically expanded using an expansion mandrel that is moved along the internal diameter of the string. Problems arise if a connector is damaged, for example, during tubular string deployment in the well or during transportation. Even small damages to the connector, such as scratches, abrasions or sharp dents, which are not harmful to the main body of the tubular, may result in catastrophic failure of the connector during its plastic radial expansion.

FIG. 1 generally shows a radially-expandable threaded tubular assembly connection as known in the prior art. The tubular assembly 1 generally comprises a radially-expandable male threaded element 2 having external male threading 3 and a free end 4, a radially expandable female threaded element 5 having internal female threading 6 and a free end 7. The male and female threaded elements 2, 5 may be, for example, radially-expandable tubing, casing, or other solid expandable tubulars. In at least the oil and gas well drilling art, the male threaded element 2 is commonly referred to as a “pin” or “pin member” and the female threaded element 5 is commonly referred to as a “box” or “box member.” The pin 2 and box 5 are coupled together by threading the pin 2 into the box 5 and applying a desired, and usually predetermined, amount of torque to form the tubular assembly 1, often referred to as “joint,” or “threaded connection.” It should be noted that a box member may also be formed as a coupling that provides a tubular assembly having two tubulars with pin members that are joined by a coupling having two box member elements. Thus, instead of the tubulars having a box member at one end and a pin member at the other end, the tubulars may have pin members at both ends that are joined with adjacent tubulars with the box members in the form of a coupling.

It is important to maintain the strength of the piping throughout the pipe string, including in the area of the threaded connection. The threaded connection portion of the piping is of some concern because the threaded and tapered portions of the box and pin have reduced wall thickness in those areas. As these tubular members are joined together and inserted into the wellbore, abrasion of the outer surface of the box member may occur as the members slide into the wellbore and such abrasions may develop into cracks that propagate through the wall and cause leakage or failure of the tubular members at the joint.

It is known to provide sleeves about the joints to reinforce connections before and after radial expansion of the connections. For example, International Publication Number WO 2004/074622 of Scott, et al. and WO 2004/003416 A1 of Verger, et al. provides examples of sleeves that may be provided in these areas.

As may be imagined, the shear forces exerted on these joints and sleeves are high as the joints are lowered into the wellbore and it is important that the sleeves remain in position while the tubular members are being inserted into the wellbore. However, the prior art sleeves have been designed with an attachment method including a small flange which is expensive to manufacture and does not provide significant security to the sleeve or its position on the connector against shear forces. Therefore, there is a need to provide sleeves that can withstand the forces placed upon them so that they don't slide along the pipe, rotate about the pipe or collapse as the pipe is lowered into the well or is otherwise handled or processed. Additionally, there is a need to prevent the propagation of cracks from such sleeves so that cracks do not propagate into the box member.

### SUMMARY OF THE INVENTION

The present invention provides tubular connections and method for making tubular connections. In a particular embodiment of the present invention, a tubular connection includes a box member at the end of a tubular or a coupling having an internal thread, an outer sleeve disposed about the box member and a bonding layer bonding the outer sleeve to the box member. The present invention is particularly useful, but not limited to, radially-expandable tubular connections used in the oil and gas drilling and production industries. Particular embodiments of the present invention are further useful for preventing a crack from propagating from the protective sleeve into the box member, especially when the tubular connection is undergoing radial expansion.

The bonding material that forms the bonding layer between the box member and the outer sleeve may be of any suitable bonding material such as, for example, an adhesive, a retaining compound, an anaerobic cure adhesive, solder, brazing metal, weld material or combinations thereof. In particular embodiments of the present invention, to provide a bonding layer that will blunt or arrest crack propagation before a crack reaches the box member, the bonding layer is characterized as having a bonding strength that does not exceed a threshold crack-propagating bonding strength. The threshold crack-propagating bonding strength is typically equal to about one-fifth of the cohesive strength of the box member.

In particular embodiments of the present invention, the thickness of the outer sleeve is greater than about 0.02 inches and preferably, is between about 0.04 and about 0.1 inches. The outer sleeve may be of any suitable pliable material including, for example, metals, ductile steel, stainless steel, steel alloys, copper, brass, synthetic thermoplastic, fiber composite material or combinations thereof.

In a particular embodiment of the present invention, a method for protecting a box member of a radially-expandable tubular connection includes the steps of applying a bonding material to form a bonding layer to an outer surface of the box member, an inner surface of an outer protective sleeve, or combinations thereof; disposing the outer sleeve about the box member; and bonding the outer sleeve to the box member with the bonding material. The bonding material may be any suitable bonding material such as, for example, an adhesive, a retaining compound, an anaerobic cure adhesive, solder, brazing metal, weld material or combinations thereof. In particular embodiments, the bonding layer has a bonding strength that is less than a threshold crack-propagating bonding strength.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a perspective view, partially in section, of a radially-expandable threaded tubular assembly connection as known in the prior art.

FIGS. 2A-2B are fragmentary, radial cross-sectional views of a radially-expandable tubular connection.

FIG. 2C is a fragmentary, radial cross-sectional view of a radially-expandable tubular connection having a blunted crack in accordance with the present invention.

### DETAILED DESCRIPTION OF PREFERRED EMBODIMENTS

The present invention provides tubular connections and methods for making tubular connections that are useful for joining tubular members together to form a pipe string. These tubular connections and methods are useful in the oil and gas drilling and production industries but the invention is not thereby so limited. The present invention is particularly useful for joining together radially-expandable tubular members used in the oil and gas drilling and production industries.

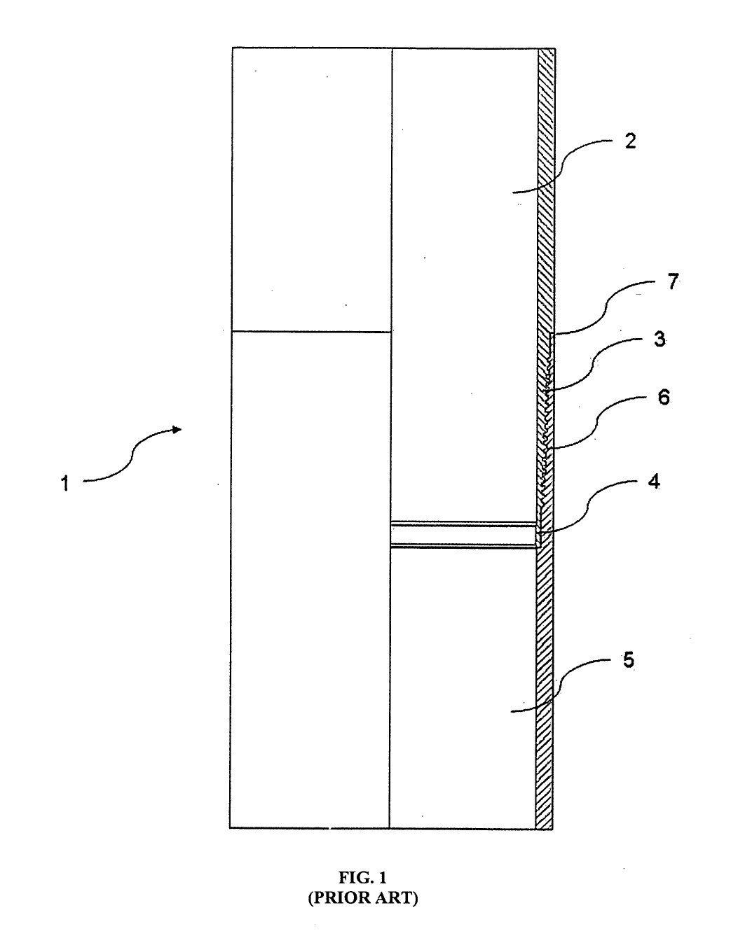

A particular embodiment of a tubular connection of the present invention includes a box member having an internal thread for joining with a pin member of a tubular member. The wall thickness of the box member is significantly reduced from the overall thickness of the tubular member because the box member is typically both internally tapered and threaded as shown in FIG. 1. Preferably, the box member may be protected with a protective outer sleeve that is disposed about the box member. The outer sleeve protects the thin-walled portion of the box member from damage such as, for example, scratches, sharp dents, cuts, nicks and scuffing that can occur during handling, transportation or lowering of the joined tubular members into the well. While such damage to the thick portions of the tubular member will typically not result in mechanical failure of the tubular member, there is concern that the thinner-walled portions of the box member, if not protected with the outer sleeve, may begin to crack from such damage and thereby result in mechanical failure.

In particular embodiments of the present invention, the tubular connection further includes a bonding layer to bond the outer sleeve to the box member. The bonding layer preferably comprises any suitable material that is characterized as having a shear strength high enough to prevent the outer sleeve from sliding along the joined tubular members or from rotating about the box from forces that may be typically applied to the sleeve. Such forces include those forces applied to the outer sleeve during, for example, transportation, handling or lowering the joined tubular members into the well. These forces are typically shear forces that tend to displace the sleeve along the length of the joined tubular members or tend to cause the sleeve to rotate about the box member.

As will be discussed in more detail below, in particular embodiments of the present invention it is neither required nor desired that the bonding material possess high bonding strength. The bonding strength is the strength the adhesive or bonding material may exert against (or apply to withstand) decoupling forces in the direction perpendicular to the bonded surfaces (ASTM D897-01).

Suitable materials useful for bonding the outer sleeve to the box member include, for example, adhesives, retaining compounds, solders, brazing metals, welding materials or combinations thereof. Adhesives having high shear strength and relatively low adhesive strength are generally known as retaining compounds. Retaining compounds are often used to assemble cylindrical press and slip-fit parts and to fill the inner space between these cylindrical components. For example, TORQUE 20RC from Adhesive Systems, Inc., is a retaining compound useful for joining fitted cylindrical parts and provides shear strength of about 4000 psi on steel and can fill diametrical gap distances of up to about 0.015 inches. TORQUE 20RC has very low adhesive strength, thus it secures the sleeve on the box member and acts as an excellent crack arrester. Retaining compounds useful for the present invention include, but are not limited to, some anaerobic cure adhesives.

In particular embodiments of the present invention, the bonding layer is preferably characterized as lacking a strong bonding strength so that the bonding layer formed between the box member and the outer sleeve is sufficiently weak to act as a propagating crack arrester. Therefore, in particular embodiments of the present invention, suitable bonding materials preferably include those that form a bonding layer capable of arresting or blunting the propagation of a crack that begins in the protective sleeve before the crack propagates to the wall of the box member. Such bonding materials may be characterized as having an adhesive or tensile strength that is less than the threshold crack-propagating bonding strength. The threshold crack-propagating bonding strength is the lowest bonding strength at which a crack will propagate from the outer sleeve, across the bonding layer and into the box member.

For example, if the protective outer sleeve disposed about the box member is damaged by, for example, a nick or a scratch, a crack may form in the protective sleeve initiated by the nick or scratch. The crack may propagate through the outer sleeve to the bonding layer that bonds the outer sleeve to the box member. As the crack approaches the bonding layer at roughly a right angle, the tension stresses perpendicular to the direction of the crack propagation ahead of the crack tip will reach the bonding layer and try to open the layer by pulling the two sides apart. If the bonding strength of the bonding layer is equal to or greater than the threshold crack-propagating bonding strength, then the interface will not be broken and the crack will cross the bonding layer and continue propagating through the box member, possibly resulting in mechanical failure of the tubular connection. However, if the bonding strength of the bonding layer is less than the threshold crack-propagating bonding strength, then the interface will be broken before the main crack reaches it, thereby arresting or blunting the crack propagation before the crack reaches the box member.

Generally, the threshold crack-propagating bonding strength is about one-fifth of the general cohesive strength of the solid at the interface. Therefore, in particular embodiments of the invention that include the crack propagation blunting property of the bonding layer, the adhesive or bonding strength of the bonding layer is less than about one-fifth of the general cohesive strength of the box material. For a typical material used for the box member, such as carbon steel, the cohesive strength is about 30 to 80 kpsi.

The protective outer sleeve of the present invention protects the thin-walled portion of the box member from damage that may possibly cause mechanical failure of the box member during, for example, plastic radial expansion of the connector. As such, the protective outer sleeve is sacrificial in the sense that the protective outer sleeve may fail without causing mechanical failure of the tubular connection as long as the protective outer sleeve protects the box member from damage. The outer sleeve may be made of any suitable pliable material known to those having ordinary skill in the art. Examples of suitable materials include, for example, ductile steel, stainless steel, steel alloys, copper, brass, tin, aluminum, synthetic thermoplastic, fiber composite materials and combinations thereof. The thickness of the outer sleeve may be of any thickness suitable for a given application as known to those having ordinary skill in the art, but is preferably greater than about 0.02 inches and is more preferably between about 0.04 inches and about 0.1 inches.

Particular embodiments of the present invention further include methods for protecting a box member of a radially-expandable tubular connection. In a particular embodiment, the method includes applying a bonding material to form a bonding layer to an outer surface of the box member, inner surface of the sleeve, or both outer surface of the box member and inner surface of the sleeve, disposing the outer sleeve about the box member, and bonding the outer sleeve to the box member with the bonding material.

It should be noted that the outer protective sleeve may be disposed about the box member at any convenient time. For example, the protective sleeve may be disposed about the box member as part of the manufacturing process of the tubular connections, after the tubular members have been shipped to a location or just prior to tubular members being joined together in a tubular connection.

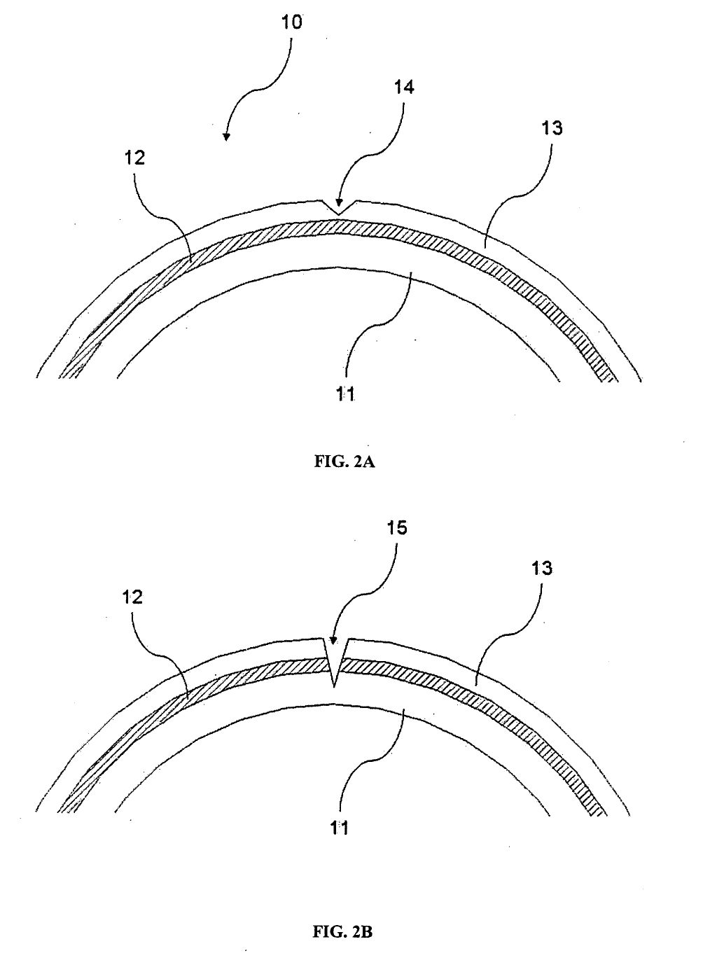

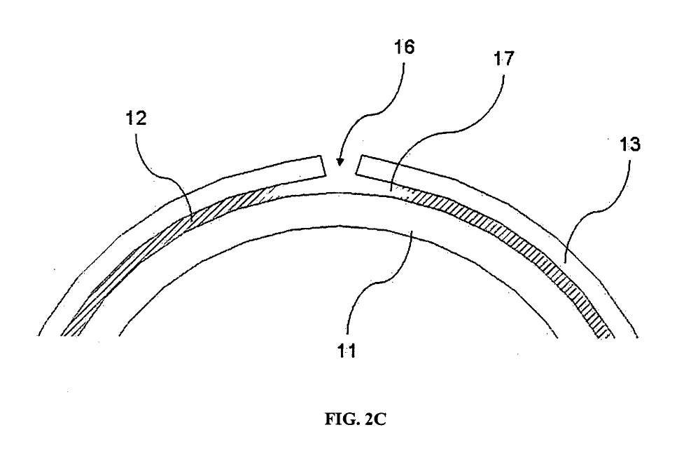

FIGS. 2A-2C are radial cross-sectional views of a radially-expandable tubular connection. FIG. 2A shows a radially-expandable tubular connection 10 that includes a box member 11, an outer protective sleeve 13 and a bonding layer 12 that bonds the box member 11 to the outer protective sleeve 13. A notch 14 is shown in the outer protective sleeve 13 as damage inflicted upon the sleeve 13. The protective outer sleeve 13 protected the box member 11 from being damaged by being notched itself.

FIG. 2B shows the radially-expandable tubular connection 10 during its radial expansion. The notch 14 in the protective outer sleeve 13 becomes a crack 15 during the radial expansion. The crack 15 is shown to have propagated through the protective outer sleeve 13, through the bonding layer 12 and into the box member 11. The crack 15 was propagated into the box member 11 because the bonding layer 12 had a bonding strength that was at or above the threshold crack-propagating bonding strength.

FIG. 2C shows a radially-expandable tubular connection 10, according to the present invention, during its radial expansion. As occurred in the case of FIG. 2B, the notch 14 in the protective outer sleeve becomes a crack 16 during the radial expansion. However, in this case, even though the crack 16 propagates through the protective outer sleeve 13, the crack 16 is blunted or arrested at the bonding layer 12 and does not continue to propagate into the box member 11. The crack 16 is blunted by forming a new crack 17 that is perpendicular to the original crack 16, thereby passing through the bonding layer 12. The crack blunting thereby effectively eliminates the stress concentration in front of the crack 16, thereby arresting the crack propagation before it reaches the box member 11. The crack 16 did not propagate into the box member 11 because the bonding layer 12 had a bonding strength that was below the threshold crack-propagating bonding strength.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A tubular connection, comprising:
a box member having an internal thread;
an outer sleeve disposed about the box member; and
a bonding layer for bonding the outer sleeve to the box member.

2. The connection of claim 1, wherein the bonding layer comprises an adhesive.

3. The connection of claim 2, wherein the adhesive is a retaining compound, an anaerobic cure adhesive or combinations thereof.

4. The connection of claim 1, wherein the bonding layer comprises solder, brazing metal, weld material or combinations thereof.

5. The connection of claim 1, wherein the bonding layer is characterized as having a bonding strength that is less than a threshold crack-propagating bonding strength.

6. The connection of claim 5, wherein the threshold crack-propagating bonding strength of the bonding layer is the lowest bonding strength at which a crack will propagate from the outer sleeve, across the bonding layer and into the box member.

7. The connection of claim 5, wherein the threshold crack-propagating bonding strength is about one-fifth of a cohesive strength of the box member.

8. The connection of claim 1, wherein a thickness of the outer sleeve is greater than about 0.02 inches.

9. The connection of claim 8, wherein the thickness of the outer sleeve is between about 0.04 and about 0.1 inches.

10. The connection of claim 1, wherein the outer sleeve comprises a metal.

11. The connection of claim 10, wherein the metal is selected from ductile steel, stainless steel, steel alloys, copper, brass or combinations thereof.

12. The connection of claim 1, wherein the outer sleeve comprises a material selected from synthetic thermoplastic, fiber composite material or combinations thereof.

13. The connection of claim 1, wherein the tubular connection is a radially-expandable tubular connection.

14. The connection of claim 1, wherein the box member is formed at an end portion of a tubular.

15. The connection of claim 1, wherein the box member is formed at an end portion of a coupling.

16. A method for protecting a box member of a radially-expandable tubular connection, comprising:
applying a bonding material to an outer surface of the box member, to an inner surface of an outer sleeve or combinations thereof;
disposing the outer sleeve about the box member;
forming a bonding layer between the outer sleeve and the box member; and
bonding the outer sleeve to the box member with the bonding material.

17. The method of claim 16, wherein the bonding material is an adhesive.

18. The method of claim 17, wherein the adhesive is a retaining compound, an anaerobic cure compound or combination thereof.

19. The method of claim 16, wherein the bonding material is selected from solder, brazing metal or combinations thereof.

20. The method of claim 16, wherein the bonding layer is characterized as having a bonding strength that is less than a threshold crack-propagating bonding strength.

21. The method of claim 20, wherein the threshold crack-propagating bonding strength of the bonding layer is the lowest bonding strength at which a crack will propagate from the outer sleeve, across the bonding layer and into the box member

22. The method of claim 20, wherein the threshold crack-propagating bonding strength is about one-fifth of a cohesive strength of the box member.
